(19) United States
(12) Patent Application Publication
(10) Pub. No.: US 2002/0111194 A1
(43) Pub. Date: Aug. 15, 2002

(54) Laptop wireless systems integrated with an LCD panel

(76) Inventors: Farbod Behbahani, Irvine, CA (US); Mehrdad Negahban, Irvine, CA (US); Lawrence Dalphy, Mission Viejo, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/021,794

(22) Filed: Dec. 11, 2001

Related U.S. Application Data
(60) Provisional application No. 60/254,702, filed on Dec. 11, 2000.

(51) Int. Cl. H04M 1/00

(52) U.S. Cl. 455/566; 455/556

(57) ABSTRACT

In general, a computing device is configured with a display panel integrated with a plurality of antennas. These antennas may enable service to multiple wireless communication systems such as, for example, a wireless local area network (WLAN), a global positioning system (GPS), a high performance radio local area network (HiperLAN/x) and/or a Bluetooth based network.

This application claims the benefit of priority on U.S. Provisional Application No. 60/254,702 filed Dec. 11, 2000.

### FIELD

The invention generally relates to the field of communications. In particular, one embodiment of the invention relates to a display panel for a computing device integrated with a plurality of antennas.

### GENERAL BACKGROUND

Currently, computers are configured with a Personal Computer Memory Card International Association (PCMCIA) card slot adapted to receive a removable PCMCIA card. Horizontally inserted into the PCMCIA card slot for retention, a PCMCIA card may be configured to operate as an antenna for wireless transmissions to a destination station. One problem with the conventional architecture is that this antenna merely supports a single operating frequency band. Thus, in order to receive communications from multiple types of wireless communication systems that operate at different frequency bands, it may be necessary for a computer user to purchase multiple PCMCIA cards and swap these cards as needed. Another problem is that the antenna is positioned horizontally and in close proximity to a table, desk or other surface supporting the computer. Hence, the antenna radiation pattern is adversely affected.

### BRIEF DESCRIPTION OF THE DRAWINGS

The features and advantages of the invention will become apparent from the following detailed description of the invention in which:

FIG. 1 is a perspective view of a first embodiment of a computing device having a display panel integrated with a plurality of antennas.

FIG. 2 is a perspective view of a second embodiment of a computing device having a display panel integrated with a plurality of antennas.

FIG. 3 is a first exemplary embodiment of a block diagram illustrating antenna connections to hardware of the laptop computer of FIG. 1.

FIG. 4 is a second exemplary embodiment of a block diagram illustrating antenna connections to hardware of the laptop computer of FIG. 1.

### DETAILED DESCRIPTION

Herein, the exemplary embodiments of the invention relate to a display panel for a computing device integrated with a plurality of antennas. The embodiments described herein are not exclusive; rather, they merely provide a thorough understanding of the invention. Also, well-known circuits are not set forth in detail in order to avoid unnecessarily obscuring the invention.

In particular, certain embodiments of the invention relate to a design for a display panel of a computing device that integrates multiple antennas into the same physical housing. These antennas, possibly radio frequency (RF) based antennas, may enable service to multiple wireless communication systems such as, for example, a wireless local area network (WLAN) in accordance with current or future IEEE 802.11 standards such as IEEE 802.11, 802.11a, 802.11b, and the like (generally referred to as “IEEE 802.11”), a global positioning system (GPS), a Bluetooth based network and/or a high performance radio local area network (HiperLAN/x). Current HiperLAN/x communications include a HiperLAN/l standard that supports communications up to 20 megabits per second (Mbps) and a HiperLAN/2 standard that supports communications up to 54 megabits per second (Mbps). In one embodiment, the antenna structures that are embedded into the display panel allow for an antenna radiation pattern that is well-formed when the display panel is positioned in its substantially vertical viewing position. Moreover, the display panel would allow for emissions compliance testing before completed assembly of the computing device.

In the following description, certain terminology is used to describe features of the invention. For example, “logic” includes hardware and/or software module(s) that perform a certain function on incoming information. For example, logic may include, but is not limited or restricted to electronic components (e.g., processor, chipset, front-end, etc.). The term “information” is defined as data, address, control or any combination thereof.

In addition, a “link” is broadly defines as one or more physical or virtual information-carrying mediums to establish a communication pathway. Examples of the medium include a physical medium (e.g., electrical wire, optical fiber, cable, bus trace, etc.) or a wireless medium (e.g., air in combination with wireless signaling technology). A “computing device” may be a computer (e.g., laptop computer, network computer, personal digital assistant or other handheld, etc.), a wireless telephone, a portable video viewing device, and the like.

I. General Architecture

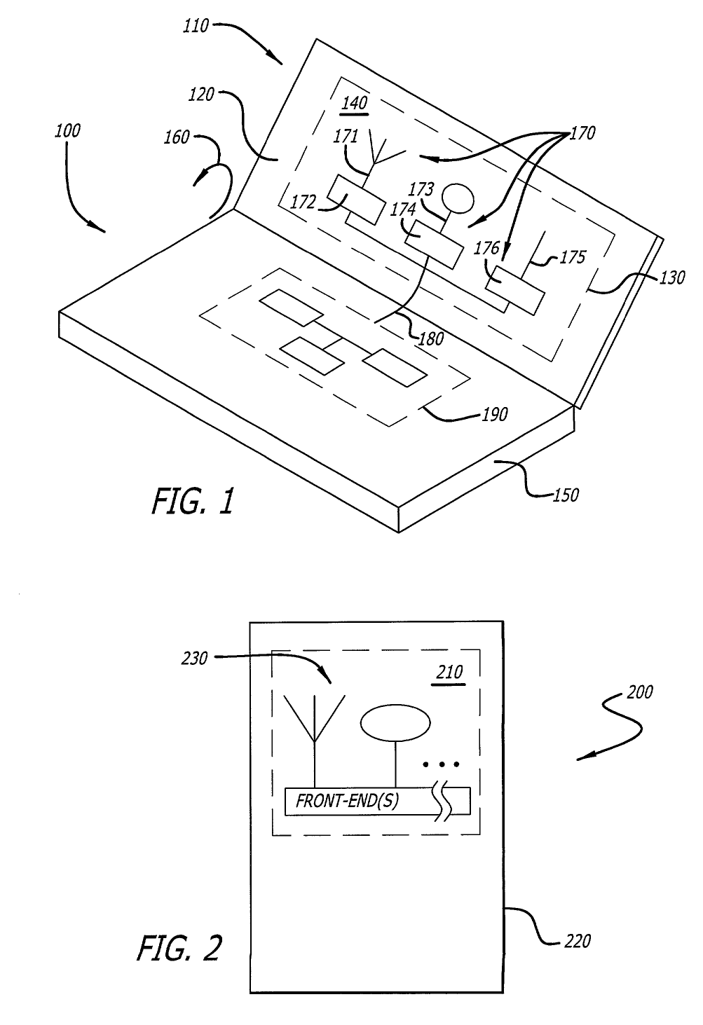

Referring to FIG. 1, a perspective view of an embodiment of a computing device having a display panel integrated with a plurality of antennas is shown. The computing device 100 comprises a display panel 110 and a chassis 150 that is physically separate from the display panel 110 and contains processing logic of the computing device 100. Normally, a top surface of the chassis 150 features an alphanumeric keyboard and perhaps a touch screen or other type of cursor control device.

For this embodiment, the display panel 110 is a liquid crystal display (LCD) featuring a housing 120 to protect a LCD screen 130 and display control logic 140. Normally made of a rigid material such as hardened plastic, the housing 120 is rotatably coupled to the chassis 150 so that the display panel 110 can be adjusted along a rotational axis 160.

Placed within the housing 120, the display control logic 140 may include backlight logic (not shown) for the LCD screen 130 and/or a plurality of antennas 170 associated with a plurality of operating frequency bands. The rotational coupling of the housing 120 to the chassis 150 enables the radiation patterns of the antennas 170 to be well formed when the display panel 110 is oriented in a substantially vertical orientation while the chassis 150 remains in a substantially horizontal orientation.

As shown, one of these antennas 170 includes first antenna 171 operating at a center frequency of approximately 2.4 Gigahertz (GHz). The first antenna 171 may be controlled by front-end 172 fully or partially contained within the housing 120. This configuration allows the computing device 100 to be part of a wireless local area network (WLAN). The front-end 172 may control amplification of signals, segmentation (depacketization) of digital information received from another WLAN device, reassembly (packetization) of digital information prior to transmission to another WLAN device, conversion between analog and digital signal formats or any combination thereof. The front-end 172 may include, but is not limited or restricted to a power amplifier and/or a low-noise amplifier.

Another of the antennas 170 includes second antenna 173 operating at an operating frequency band of 1.575 GHz. The second antenna 173 may also be controlled by front-end 174 fully or partially contained within the housing 120. For instance, the front-end 174 may partially control amplification of signals and/or depacketization of digital information received from one or more satellites in communication with the computing device.

Yet another of the antennas 170 includes a third antenna 175 operating at an operating frequency band between approximately 2.4-2.5 GHz (Bluetooth) or 5.15-5.825 GHz for HiperLAN/x. The third antenna 175 may also be controlled by front-end 176 fully or partially contained within the housing 120. The front-end 176 controls amplification of signals received from or transmitted to at least one Bluetooth or HiperLAN/x compatible networking devices as well as packetization or depacketization as needed.

Upon receipt and at least partial processing of a signal by one the antennas 170, the processed signal is routed over a link 180 to a circuit board 190 employed within the chassis 150. The circuit board 190 may be a motherboard, a daughter card and the like. Normally, the link 180 already exists due to a required connection between the LCD screen 130 and the processing logic within the chassis 150. The processed signal may be analog or digital in format, depending on the selected operations of the particular front-end 172, 174 and/or 176.

Referring now FIG. 2, a perspective view of another embodiment of a computing device having a display panel integrated with a plurality of radio frequency (RF) antennas is shown. The computing device 200 comprises a display 210 integrated into the same chassis 220 as the processing logic. For this embodiment, the chassis 220 features a plurality of RF antennas 230 associated with a plurality of operating frequency bands. Since the computing device is hand-held, the radiation patterns of the RF antennas 230 to be well formed when the computing device 200 is oriented in a substantially vertical orientation during normal use.

As similarly described above, the plurality of RF antennas 230 operate at different center frequencies. This enables the computing device to receive and transmit signals in supporting communications with different wireless communication systems such as, for example, a wireless local area network (WLAN), a global positioning system (GPS), a Bluetooth or HiperLAN/x based network and the like.

II. Antenna Connections

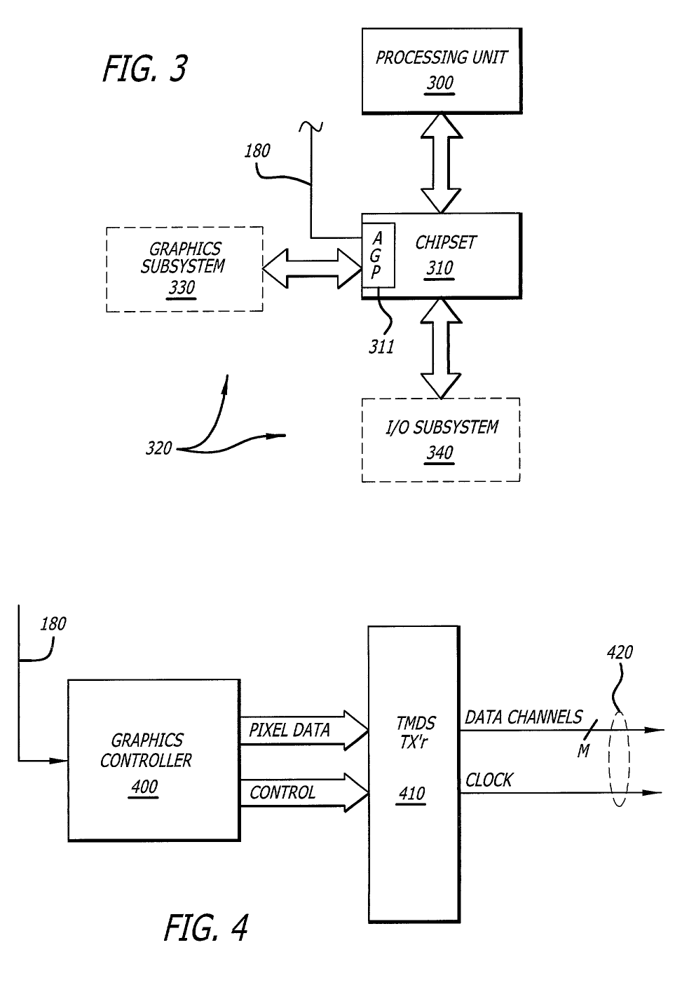

Referring now to FIG. 3, an exemplary embodiment of a block diagram illustrating antenna connections to logic of the computing device (e.g., computing device 100) is shown. The computing device 100 comprises a processing unit 300 for processing information (e.g., a microprocessor, a digital signal processor, a microcontroller, an application specific integrated circuit, etc.) and a chipset 310 for routing information to one or more subsystems 320 of the computing device 100. These subsystems 320 may include, but are not limited or restricted to a graphics subsystem 330 and/or an input/output (I/O) subsystem 340.

In one embodiment, the link 180 is coupled at one end to the RF antennas 170 and is also coupled to an accelerated graphics port (AGP) port 311 of the chipset 310 at the other end. Alternatively, as shown in FIG. 4, the link 180 may be a Digital Visual Interface (DVI) cable coupled to a graphics controller 400, which in turn is coupled to a Transition Minimized Differential Signaling (TMDS) transmitter 410 of a DVI interface 420. Of course, although not shown, in the event that the front-ends 172, 174 or 176 further process the signal and extract the digital information, link 180 may be coupled directly to an input/output (I/O) bus such as a Peripheral Component Interconnect (PCI) bus, and Industry Standard Architecture (ISA) bus, a Universal Serial Bus (USB) bus and the like.

While certain exemplary embodiments have been described and shown in the accompanying drawings, it is to be understood that such embodiments are merely illustrative of and not restrictive on the broad invention, and that this invention should not be limited to the specific constructions and arrangements shown and described.

What is claimed is:

1. A computing device, comprising:
a chassis that contains information processing logic; and
a display panel rotatably coupled to the chassis, the display panel including a housing to contain a display screen and a plurality of antennas each operating at a different center frequency.

2. The computing device of claim 1, wherein each of the plurality of antennas is coupled to a dedicated front-end.

3. The computing device of claim 2, wherein the dedicated front-ends associated with the plurality of antennas is contained within the housing.

4. The computing device of claim 2, wherein the corresponding plurality of front-ends are coupled to the information processing logic of the chassis through a link.

5. The computing device of claim 1, wherein the chassis includes a top surface integrated with an alphanumeric keyboard.

6. The computing device of claim 1, wherein the plurality of antennas contained in the housing of the display panel enable service to a wireless local area network operating in accordance with an IEEE 802.11 standard and at least one of a Bluetooth based network and a HiperLAN/x based network.

7. The computing device of claim 6, wherein the plurality of antennas contained in the housing of the display panel further enable service to a global positioning system.

8. The computing device of claim 1, wherein the plurality of antennas contained in the housing of the display panel enable service to a Bluetooth based network and at least one of a global positioning system and a HiperLAN/x based network.

9. The computing device of claim 1, wherein the plurality of antennas contained in the housing of the display panel enable service to at least two of a wireless local area network operating in accordance with an IEEE 802.11 standard, a global positioning system, a Bluetooth based network and a HiperLAN/x based network.

10. The computing device of claim 1, wherein the plurality of antennas receive RF signals having different center frequencies.

11. Configured for a computing device, a display panel comprising:
a housing;
a display screen having a backside partially protected by the housing; and
a plurality of antennas placed within the housing, each of the plurality of antennas operating at a different center frequency.

12. The display panel of claim 11, wherein each of the plurality of antennas is coupled to a dedicated front-end.

13. The display panel of claim 11, wherein the display screen is a liquid crystal display (LCD) screen.

14. The display panel of claim 11, wherein the plurality of antennas enable service to at least two of a wireless local area network, a global positioning system, a high performance radio local area network, and a Bluetooth based network.

15. A computing device comprising:
a chassis to protect logic including a processor and a chipset coupled to the processor; and
a display panel including a housing partially surrounding a display screen and substantially containing a plurality of antennas each operating at a different center frequency, the display panel in communication with the logic protected by the housing.

16. The computing device of claim 15, wherein each of the plurality of antennas is coupled to a unique front-end, each front-end being coupled to a link.

17. The computing device of claim 16, wherein the link is coupled to an accelerated graphics port of the chipset employed within the chassis.

18. The computing device of claim 16, wherein the link is a digital visual interface (DVI) cable.

19. The computing device of claim 18, wherein the DVI cable is coupled to a graphics controller being part of the logic implemented within the chassis.

20. The computing device of claim 19, wherein the graphics controller is coupled to a Transmission Minimized Differential Signaling (TMDS) transmitter.
